(19) United States
(12) Patent Application Publication
(10) Pub. No.: US 2020/0391462 A1
(43) Pub. Date: Dec. 17, 2020

(54) TIRE BUILDING MACHINE

(71) Applicant: Bridgestone Americas Tire Operations, LLC, Nashville, TN (US)

(72) Inventors: Jason J. Para, Franklin, TN (US); Phillip T. Brasher, Jr., Nashville, TN (US)

(21) Appl. No.: 16/305,532

(22) PCT Filed: Apr. 26, 2017
(86) PCT No.: PCT/US2017/029605

§ 371 Date: Nov. 29, 2018

Related U.S. Application Data
(60) Provisional application No. 62/347,042, filed on Jun. 7, 2016.

(51) Int. Cl. B29D 30/30; B29D 30/26

(52) U.S. Cl. CPC B29D 30/3007; B29D 30/26

(57) ABSTRACT

A tire building machine for assembling tire plies to build a tire carcass may include a drum for receiving the tire plies. The tire building machine may also include a retractable backing strip. The retractable backing strip may be configured to extend over the drum. The tire building machine may further include a stitcher. The stitcher may be configured to stitch ends of the tire plies when the ends are between the stitcher and the retractable backing strip.

### BACKGROUND

The present disclosure relates generally to a tire building machine for assembling tire plies to build a tire carcass. The present disclosure also relates generally to a method of building a tire.

Tire building machines require a worker to supervise and assist in the process of building the tire. Particularly, when a tire ply needs to be stitched together, a worker often must pull the ends of the tire ply together to ensure they butt against each other prior to stitching the ends together with a stitcher. Steps involving a worker assisting the tire building machine can be undesirable in that they slow down production speeds and also require a worker to be present.

### BRIEF SUMMARY

What is needed, therefore, is an apparatus and method for preventing the tire ply ends from sticking to the inner liner in order for the stitcher to successfully carry out the stitching operation with minimal or no help from a worker to pull the ends of the tire ply together. One exemplary embodiment includes a retractable backing strip that functions much like a traditional measuring tape. The retractable backing strip may be temporarily placed between the inner liner and the tire ply under the tire ply ends and removed after the stitching operation has completed.

The present disclosure relates to a tire building machine for assembling tire plies to build a tire carcass. In one embodiment, the tire building machine may include a drum for receiving the tire plies. The tire building machine may also include a retractable backing strip. The retractable backing strip may be configured to extend over the drum. The tire building machine may further include a stitcher. The stitcher may be configured to stitch ends of the tire plies when the ends are between the stitcher and the retractable backing strip.

Another embodiment of the tire building machine may include the drum further including a drum diameter and a rotation axis. The retractable backing strip may be further configured to extend over the drum parallel to the rotation axis in an extended position, retract into a storage position, and index with the drum so that the retractable backing strip may be precisely located with respect to the ends of the tire plies. The stitcher may be further configured to traverse parallel to the rotation axis with the retractable backing strip between the stitcher and the drum so that the stitcher may pull together and stitch the ends of the tire plies.

Yet another embodiment may include the retractable backing strip further configured to prevent the ends of the tire plies from sticking to an inner layer of the tire carcass.

Still another embodiment may include the retractable backing strip including a material configured to prevent the ends of the tire plies from sticking to the retractable backing strip.

An alternative embodiment may include the material including a non-stick coating.

Alternative embodiments may include a motor configured to retract the retractable backing strip.

Another embodiment may include the retractable backing strip connected to the drum.

A further embodiment may include the retractable backing strip being flexible and configured to retract into a coil in a storage position.

A further still embodiment may include a bead setter configured to extend the retractable backing strip over the drum.

Yet another embodiment may include the retractable backing strip including an inflatable backing strip.

Some embodiments of a tire building machine for assembling tire plies to build a tire carcass may include a stitcher. The stitcher may be configured to stitch together ends of the tire plies. The machine may also include a non-stick layer. The non-stick layer may be configured to be located under the ends of each of the tire plies and to allow the ends to slide closer together when the ends are engaged by the stitcher.

Another embodiment may include the non-stick layer further configured to be removed after the stitcher has stitched together the ends of the tire plies.

Further embodiments may include a drum. The drum may be configured to receive the tire plies.

Other embodiments may include the non-stick layer further configured to be used multiple times in building the tire carcass.

Still another embodiment may include the non-stick layer further configured to inflate to separate itself from the tire ply.

The present disclosure also relates to a method of building a tire. The method may include placing a tire ply pre-assembly on a tire ply receiving drum; extending a backing strip over the tire ply pre-assembly on the tire ply receiving drum; placing a tire ply including tire ply ends on the tire ply receiving drum such that the tire ply ends are over the backing strip; stitching the tire ply ends together with a tire ply stitcher; and retracting the backing strip into a storage position.

Another embodiment of the method may further include pulling the tire ply ends together with the tire ply stitcher.

Some embodiments of the method may include using a motor to retract the backing strip into a storage position.

Still other embodiments of the method may include extending the backing strip over the tire ply on the tire ply receiving drum; placing a second tire ply including second tire ply ends on the tire ply receiving drum such that the tire ply ends are over the backing strip; stitching the second tire ply ends together with the tire ply stitcher; and retracting the backing strip into the storage position.

An embodiment of the method may further include indexing the backing strip with the tire ply receiving drum.

Yet another embodiment of the method may include stitching the tire ply ends together against the backing strip with the tire ply stitcher.

A further embodiment of the method may include extending the backing strip over the tire ply pre-assembly on the tire ply receiving drum with a bead setter.

A still further embodiment of the method may include inflating the backing strip.

Numerous objects, features, and advantages of the present invention will be readily apparent to those skilled in the art upon a reading of the following disclosure when taken in conjunction with the accompanying drawings.

### BRIEF DESCRIPTION OF THE SEVERAL VIEWS OF THE DRAWINGS

FIG. 1 is a schematic side elevation view of an embodiment of a tire building machine with a backing strip in an extended position.

FIG. 2 is a schematic side elevation view of the tire building machine of FIG. 1 with a cross-sectional view of a dispenser with the backing strip in a storage position.

FIG. 3 is a schematic perspective view of a drum of the tire building machine of FIG. 1 with the backing strip in the storage position.

FIG. 4 is a schematic perspective view of the drum of FIG. 3 with the backing strip in the extended position.

FIG. 5 is a schematic top plan view of the drum in FIG. 3.

FIG. 6 is a schematic front elevation view of the tire building machine of FIG. 1 prior to the stitcher stitching together the tire ply ends.

FIG. 7 is the view of FIG. 6 after the stitcher has stitched together the tire ply ends.

FIG. 8 is the view of FIG. 6 while the inflatable backing strip is inflated.

FIG. 9 is the view of FIG. 6 after the inflatable backing strip has been deflated.

FIG. 10 is a schematic side elevation view of another embodiment of a tire building machine.

### DETAILED DESCRIPTION

Various embodiments of the present invention will now be described with reference to the accompanying drawings. Many embodiments are contemplated. The disclosure should not, however, be construed to be limited to the embodiments set forth herein.

By way of introduction, automation of the tire building process is a highly desirable goal in the industry. Automating even a small aspect of the tire building process can be beneficial. The inventors of the current disclosure have recognized the stitcher 122 used in tire building is strong enough to bring the tire ply ends 114 together without a worker pulling them into place. The discovered trouble arises, however, in that the tire ply ends 114 tend to stick to the previous tire ply underneath (or the inner layer) 116 during the stitching operation. Preventing this sticking would allow the stitcher 122 to bring the tire ply ends 114 together for stitching on its own with fewer worker-made adjustments. With the ends 114 free to be moved, the tire building process may be more automated than previously known because the size of the gap between the tire ply ends is much less critical.

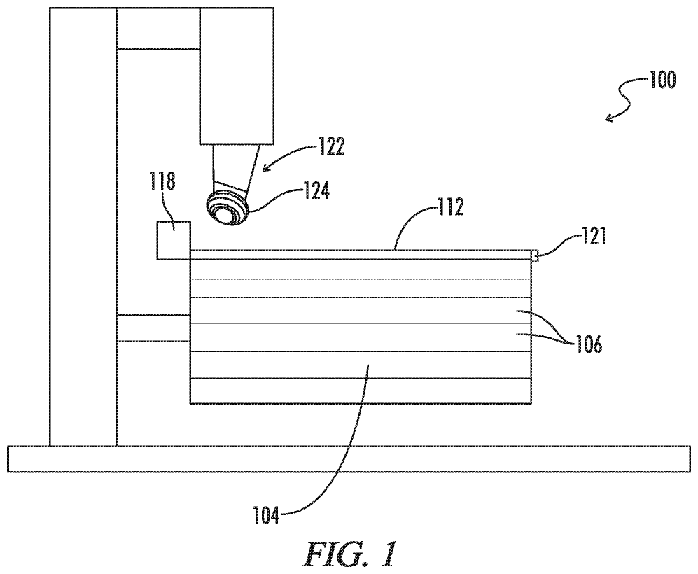

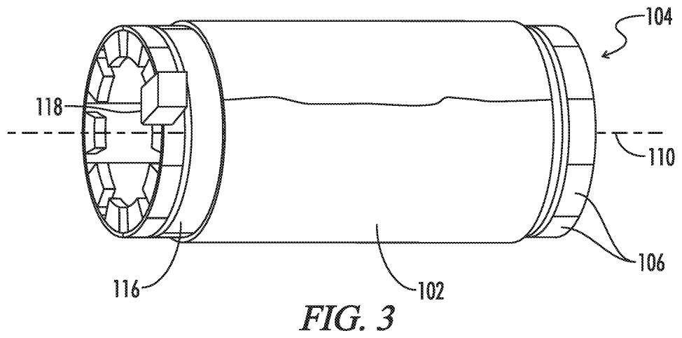

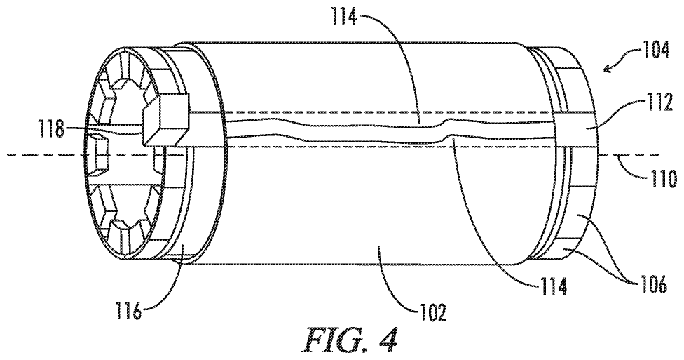

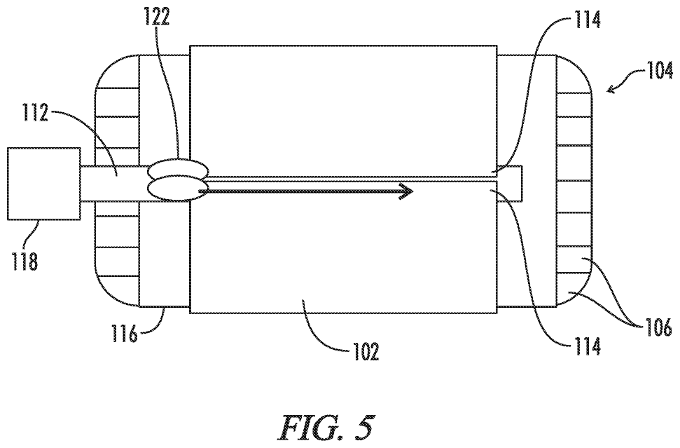

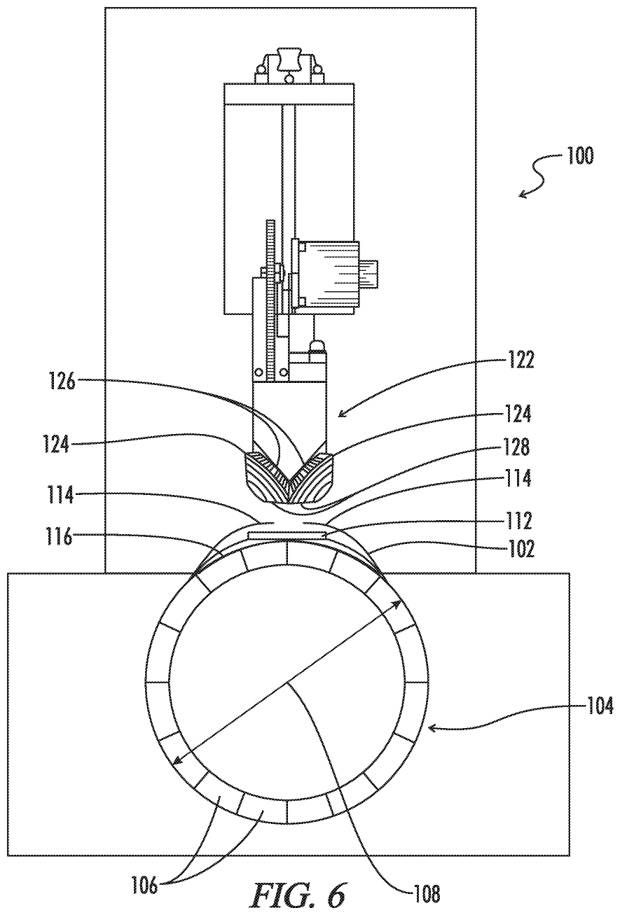

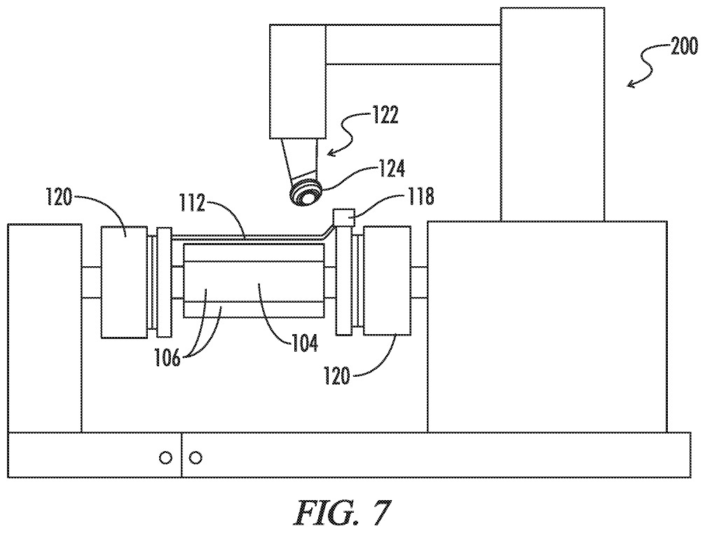

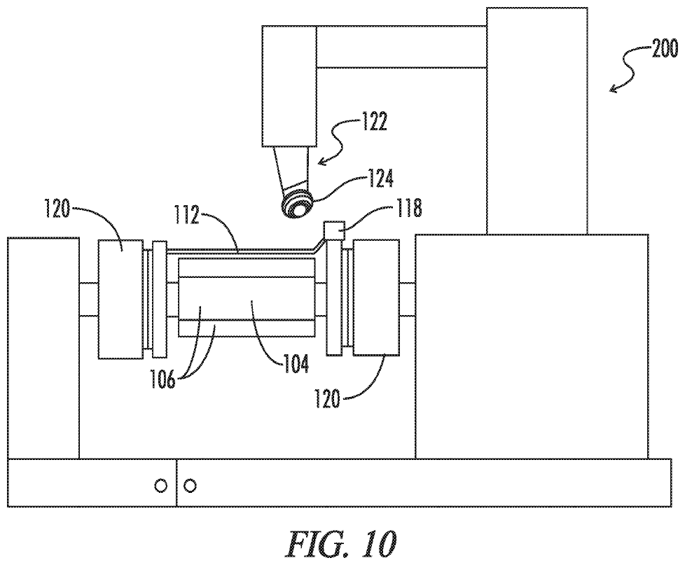

Referring now to FIGS. 1-7, an embodiment of a tire building machine 100 (as shown in FIG. 1), or tire building machine 200 (as shown in FIG. 7) may be used to assemble tire plies 102 in order to build a tire carcass. The tire building machine 100 may include a drum 104. The drum 104 may receive the tire plies 102 (as shown in FIGS. 3-6). The drum 104 may be any suitable drum used in tire building. In a non-limiting example, the drum 104 may be attached to the rest of the tire building machine 100 on one end (as shown in FIG. 1). In an alternative non-limiting example, the drum 104 may be attached to the rest of the tire building machine 200 on both ends (as shown in FIG. 10). In some embodiments, the drum 104 may be rotatable relative to the rest of the tire building machine manually, by the use of a motor (not shown), or both. Further, the drum 104 may include a single and uninterrupted drum wall, or may include many drum wall sections 106. As shown in FIG. 6, the drum 104 may also include a drum diameter 108. As shown in FIGS. 3 and 4, the drum 104 may further include a rotation axis 110.

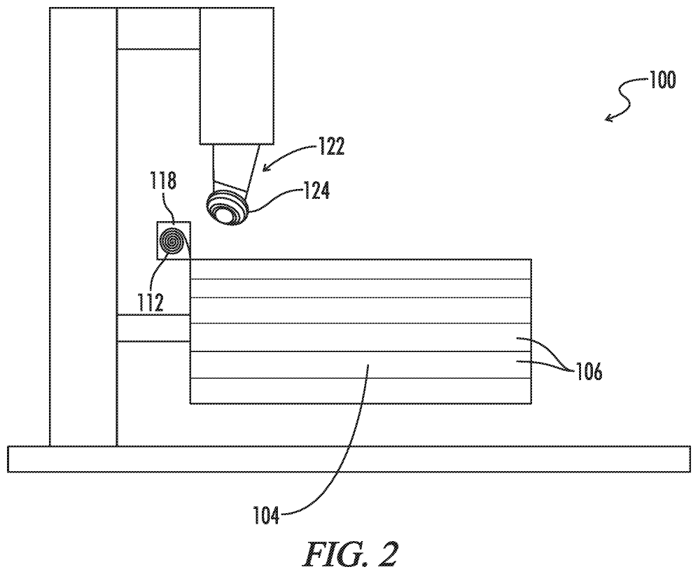

The tire building machine 100 may also include a backing strip 112. The backing strip 112 may be configured to extend over the drum 104. The backing strip 112 may also be a retractable backing strip. The backing strip 112 may have a non-stick layer, such as polytetrafluoroethylene (more commonly known as TEFLON). In some embodiments, the backing strip 112 may be made mostly or completely from a non-stick material. The backing strip 112 may be configured to extend over the drum 104. In some embodiments, the backing strip 112 may be configured to extend over the drum 104 parallel to the rotation axis 110 in an extended position (shown in FIGS. 1 and 4-7). The backing strip 112 may be further configured to retract into a storage position (shown in FIGS. 2 and 3). Also, the backing strip 112 may be configured to index with the drum 104. The indexing may be performed with a motor connected to the drum 104 or may be performed manually by a user. In such embodiments, the backing strip 112 may be precisely located with respect to the ends 114 of the tire plies 102. In one embodiment, the backing strip 112 may be connected to the drum 104.

The backing strip 112 may be configured to prevent the ends 114 of the tire plies 102 from sticking to an inner layer 116 of the tire carcass. Some embodiments of the tire building machine 100 may include the backing strip 112 including a material configured to prevent the ends 114 of the tire plies 102 from sticking to the backing strip. In a particular embodiment, the material may include a non-stick coating such as polytetrafluoroethylene (commonly known as TEFLON).

The tire building machine 100 may also include a motor 101 configured to retract the backing strip 112 into the storage position. The motor 101 may also be configured to extend the backing strip 112. In some embodiments, the backing strip 112 is flexible and configured to retract into a coil in the storage position (shown in FIG. 2). In one embodiment, a spring or resilient member may be configured to bias the backing strip 112 toward the storage position. The tire building machine 100 may include a dispenser 118 configured to hold the backing strip 112 in a coil in the storage position and to dispense the backing strip into the extended position. An exemplary embodiment may include the motor 101 connected to a coil axle in the dispenser 118 such that actuation of the motor in a first direction would cause the coil to wrap on itself further. Actuation of the motor 101 in a second direction may cause the coil to unwind and extend the backing strip 112 to the extended position. In the extended position, the backing strip 112, or non-stick layer, may be configured to be located under the ends 114 of each of the tire plies 102.

An embodiment of the tire building machine 100 (for instance, as shown in FIG. 10) may also include a bead setter 120 configured to extend the backing strip 112 over the drum 104. As shown in FIG. 1, some embodiments of the backing strip 112 may include a catch 121 configured to hook onto an appropriate location, such as the end of the drum 104, to hold the backing strip in the extended position. The bead setter 120 may hook the catch 121 and pull the backing strip 112 to the extended position. A mechanism added to the bead setter 120 may then release the backing strip 112 over an appropriate hook location such that the catch 121 then hooks onto the hook location.

The backing strip 112 may be further configured to be used multiple times in building the tire carcass. In a non-limiting example, the backing strip 112 may extend from the dispenser 118, be located in the extended position under the ends 114 of a tire ply 102, allow the tire ply ends to be stitched together, and be retracted into the dispenser into a storage position. Then, the process may be repeated for subsequent tire plies 102. Some embodiments of the tire building machine 100 include the backing strip 112 extending and retracting automatically with at least one motor 101, while other embodiments may include an operator manually extending and retracting the backing strip. In embodiments wherein the operator manually extends and retracts the backing strip 112, the function of the backing strip and the dispenser 118 may work much like a common measuring tape. A worker may extend the backing strip 112 from the coil in the dispenser 118 against the force of a spring. A worker may then hook the catch 121 onto an appropriate location to maintain the backing strip 112 in the extended position. To store the backing strip 112 once more, a worker may remove the backing strip from under the recently stitched tire ply ends 114. This removal step may be facilitated by a non-stick coating such as polytetrafluoroethylene or by the use of a blower 103 configured to blow air under the tire ply 102 to release the backing strip 112 if it is stuck to the recently stitched tire ply ends 114. Some embodiments of the backing strip 112 are made entirely of a non-stick material such as metal or plastic. The worker may then unhook the catch 121 and release the backing strip 112 so the spring may retract the backing strip into the storage position.

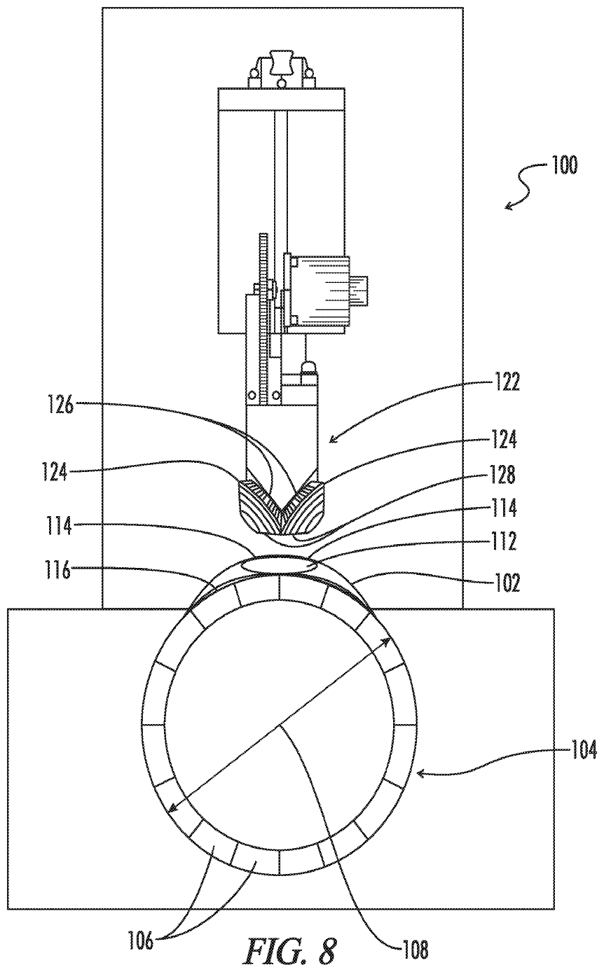

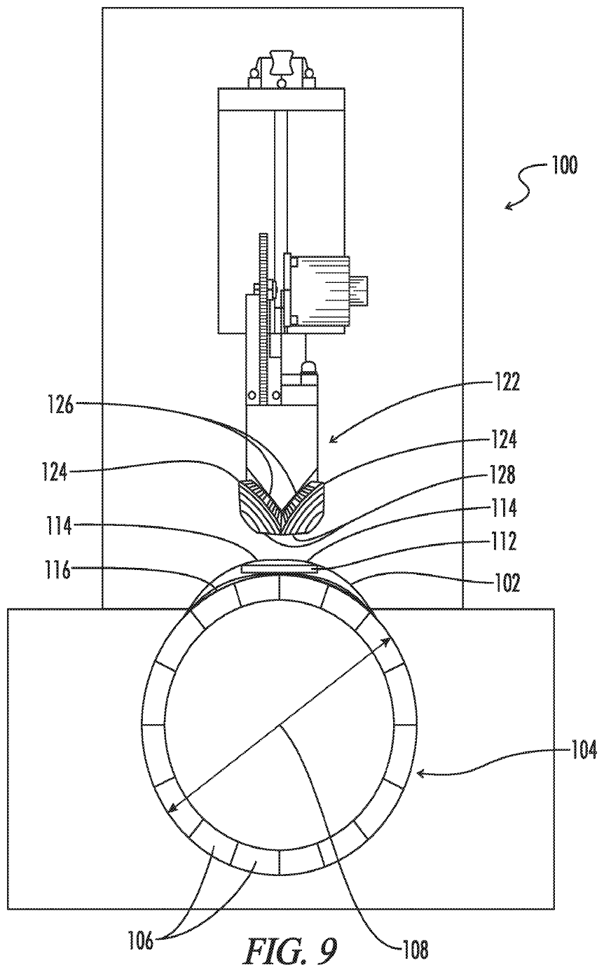

In some embodiments of the tire building machine 100, the backing strip 112 may be an inflatable backing strip. After the tire ply ends 114 have been stitched together, the ends may be stuck to the backing strip 112 (as shown in FIG. 7). To aid in the release of the backing strip 112 from the tire ply ends 114, the backing strip may be inflated (as shown in FIG. 8). The backing strip 112 may be subsequently deflated to allow a space to form between the stitched tire ply ends 114 and the backing strip 112 (as shown in FIG. 9). The backing strip 112 may then be removed.

The tire building machine 100 may further include a stitcher 122. The stitcher 122 may be configured to stitch the ends 114 of the tire plies 102 when the ends are between the stitcher and the backing strip 112. The stitcher 122 may also be configured to traverse in a direction parallel to the rotation axis 110. The backing strip 112 may be between the stitcher 122 and the drum 104 so that the stitcher may pull together and stitch the ends 114 of the tire plies 102 together.

The stitcher 122 may be any appropriate tire ply stitching device. One example of the stitcher 122 (shown in FIGS. 1, 2, 6, and 7) may include a pair of intermeshing gears 124 that include gear teeth 126 and a tire ply engaging surface 128. The pair of intermeshing gears 124 rotates in a manner that pulls the ends 114 of the tire ply 102 horizontally toward the center of the stitcher 122. The intermeshing gears 124 may be pressed downward onto the ends 114 of the tire ply 102 so as to engage the ends while the intermeshing gears are turning. The non-stick layer 112, or backing strip, may be configured to allow the ends 114 to slide closer together when the ends are engaged by the intermeshing gears 124 of the stitcher 122. The non-stick layer 112 may be further configured to be removed once the stitcher 122 has finished stitching a given tire ply 102.

The present disclosure also relates to a method of building a tire. The method may include placing a tire ply pre-assembly, including an inner layer 116, on the tire ply receiving drum 104. The backing strip 112 may be extended over the tire ply pre-assembly on the tire ply receiving drum 104. A tire ply 102 including tire ply ends 114 may be placed on the tire ply receiving drum 104 such that the tire ply ends are over the backing strip 112. The tire ply ends 114 may be stitched together with the tire ply stitcher 122. The backing strip 112 may also be retracted into the storage position. In some embodiments, some aspects of this process may be repeated as necessary on subsequent tire plies 102. For instance, the backing strip 112 may be extended over the tire ply 102 on the tire ply receiving drum 104. A second tire ply 102 including second tire ply ends 114 may be placed on the tire ply receiving drum 104 such that the tire ply ends are over the backing strip 112. The second tire ply ends 114 may be stitched together with the tire ply stitcher 122. The backing strip 112 may once again be retracted back into the storage position.

The above disclosure is capable of numerous rearrangements, modifications, and substitutions. Thus, although there have been described particular embodiments of the present disclosure of a tire building machine, it is not intended that such references be construed as limitations upon the scope of this disclosure except as set forth in the following claims.

What is claimed is:

1. A tire building machine for assembling tire plies to build a tire carcass, the machine comprising:
a drum for receiving the tire plies;
a retractable backing strip configured to extend over the drum; and
a stitcher configured to stitch ends of the tire plies when the ends are between the stitcher and the retractable backing strip.

2. The tire building machine of claim 1, wherein:
the drum further includes a drum diameter and a rotation axis;
the retractable backing strip is further configured to extend over the drum parallel to the rotation axis in an extended position, retract into a storage position, and index with the drum so that the retractable backing strip may be precisely located with respect to the ends of the tire plies; and
the stitcher is further configured to traverse parallel to the rotation axis with the retractable backing strip between the stitcher and the drum so that the stitcher may pull together and stitch the ends of the tire plies.

3. The tire building machine of claim 1, wherein the retractable backing strip is further configured to prevent the ends of the tire plies from sticking to an inner layer of the tire carcass.

4. The tire building machine of claim 1, wherein the retractable backing strip includes a material configured to prevent the ends of the tire plies from sticking to the retractable backing strip.

5. The tire building machine of claim 4, wherein the material includes a non-stick coating.

6. The tire building machine of claim 1, further including a motor configured to retract the retractable backing strip.

7. The tire building machine of claim 1, wherein the retractable backing strip is connected to the drum.

8. The tire building machine of claim 1, wherein the retractable backing strip is flexible and configured to retract into a coil in a storage position.

9. The tire building machine of claim 1, further comprising a bead setter configured to extend the retractable backing strip over the drum.

10. The tire building machine of claim 1, wherein the retractable backing strip includes an inflatable backing strip.

11. A tire building machine for assembling tire plies to build a tire carcass, the machine comprising:
a stitcher configured to stitch together ends of the tire plies; and
a non-stick layer configured to be located under the ends of each of the tire plies and to allow the ends to slide closer together when the ends are engaged by the stitcher.

12. The tire building machine of claim 11, wherein the non-stick layer is further configured to be removed after the stitcher has stitched together the ends of the tire plies.

13. The tire building machine of claim 11, further comprising a drum configured to receive the tire plies.

14. The tire building machine of claim 11, wherein the non-stick layer is further configured to be used multiple times in building the tire carcass.

15. The tire building machine of claim 11, wherein the non-stick layer is further configured to inflate to separate itself from the tire ply.

16. A method of building a tire, the method comprising:
(a) placing a tire ply pre-assembly on a tire ply receiving drum;
(b) extending a backing strip over the tire ply pre-assembly on the tire ply receiving drum;
(c) placing a tire ply including tire ply ends on the tire ply receiving drum such that the tire ply ends are over the backing strip;
(d) stitching the tire ply ends together with a tire ply stitcher; and
(e) retracting the backing strip into a storage position.

17. The method of claim 16, further comprising pulling the tire ply ends together with the tire ply stitcher.

18. The method of claim 16, wherein step (e) is performed with a motor.

19. The method of claim 16, further comprising:
extending the backing strip over the tire ply on the tire ply receiving drum;
placing a second tire ply including second tire ply ends on the tire ply receiving drum such that the tire ply ends are over the backing strip;
stitching the second tire ply ends together with the tire ply stitcher; and
retracting the backing strip into the storage position.

20. The method of claim 16, further comprising indexing the backing strip with the tire ply receiving drum.

21. The method of claim 16, wherein step (d) is performed against the backing strip.

22. The method of claim 16, wherein step (b) is performed with a bead setter.

23. The method of claim 16, further comprising:
inflating the backing strip.
